(19) United States
(12) Patent Application Publication
(10) Pub. No.: US 2022/0215474 A1
(43) Pub. Date: Jul. 7, 2022

(54) COMPUTER SYSTEM AND METHOD FOR INVESTMENT PORTFOLIO ANALYSIS AND REBALANCE

(71) Applicant: Wells Fargo Bank, N.A., San Francisco, CA (US)

(72) Inventors: Sae Lee, Wildwood, MO (US); Carla Sleeter, Alhambra, IL (US)

(21) Appl. No.: 15/086,281

(22) Filed: Mar. 31, 2016

(51) Int. Cl. G06Q 40/06

(52) U.S. Cl. CPC G06Q 40/06

(57) ABSTRACT

A computer system and method for investment portfolio analysis and rebalance. A processer and computer application tools are provided for use in the dedicated computer system of the present invention. The processor and computer application tools are configured for custom review of an investment portfolio and investment portfolio analysis by equity sector. Tracking error logic is included as a feature of the auto-rebalance component.

### FIELD OF THE INVENTION

The present invention generally relates to a computer system and method for investment portfolio review, more particularly to a computer system and method for investment portfolio analysis and rebalance.

### BACKGROUND OF THE INVENTION

Historically in the investment community, a financial advisor either had to create an investment portfolio himself or herself or use a model investment portfolio. In the case of self-creating the investment portfolio, the portfolio was typically based off of individual security recommendations one-by-one without consideration as to mathematical correlation. However, automated systems have not been able to provide the needed degree of customization and reallocation. Thus, there is a lack of customization to specific investor needs, for example, particularly in automated computer systems.

There is a need for a computer method(s) and an application tool(s) that consider existing holdings as well as new holdings. Moreover, when existing holdings are deemed appropriate to retain in the account, there is a need for a computer system that considers the manner in which those existing holdings may correlate or interact with any new securities that are also recommended for the portfolio. Thus, there is a need for a system and method that provides those benefits, among others.

### SUMMARY OF THE INVENTION

The present invention relates to a computer system and method for investment portfolio analysis and rebalance.

In an embodiment of the present invention, a method for custom review of a portfolio in a computer system comprising a processor is provided. The processor is configured to evaluate an investment portfolio against current recommended allocations and investments to align the investment portfolio with an investment objective and a risk tolerance of an investor; review the investment portfolio against select criteria; automatically determine the tracking error; and generate a recommendation to rebalance the investment portfolio based on the tracking error.

In another embodiment of the present invention, a method for custom review of a portfolio in a computer system comprising a processor is provided. The processor is configured to identify a sector and an asset class within an investment portfolio whose allocation exceeds a tolerance limit; generate a list of securities as candidates for sale within the sector and the asset class; automatically calculate the tracking error for the list with each of the securities on the list excluded one at a time; and generate a recommendation to sell the security leaving the portfolio with the lowest tracking error relative to a benchmark for the portfolio.

In still yet another embodiment of the present invention, a method for custom review of a portfolio and a computer system comprising a processor is provided. The processor is configured to identify a sector and an asset class within an investment portfolio whose allocation is below a tolerance limit; generate a list of securities as candidates for purchase within the sector and the asset class; automatically calculate the tracking error for the list with each of the securities on the list excluded one at a time; and generate a recommendation to buy the security from the list giving the portfolio the lowest tracking error relative to a benchmark for the portfolio.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, which are not necessarily to scale, wherein:

FIG. 1 is a diagram of a dedicated computer system in accordance with aspects of the present invention.

FIG. 2 is a diagram illustrating the computer system from the perspective of a custom portfolio review (CPR) web server.

FIG. 3 is a diagram illustrating the computer system from the perspective of an equity sector portfolio analysis (ESPA) web server.

FIG. 4 is a process flow diagram of an overall computer-implemented method in accordance with aspects of the present invention.

FIG. 5 is a process flow diagram of the auto-rebalance logic for a sell process in custom portfolio review.

FIG. 6 is a process flow diagram of the auto-rebalance logic for a buy process in custom portfolio review.

FIG. 7 is a flowchart illustrating a general pre-screening method for a portfolio.

FIG. 8A is a flowchart illustrating a method for automatically populating the pre-screen list of FIG. 7 for a Mutual Fund in accordance with aspects of the invention.

FIG. 8B is a flowchart illustrating a method for automatically populating the pre-screen list of FIG. 7 for fixed income in accordance with aspects of the invention.

FIG. 8C is a flowchart illustrating a method for automatically populating the pre-screen list of FIG. 7 for an Exchange-Traded Tracking Product (ETP) in accordance with aspects of the invention.

FIG. 8D is a flowchart illustrating a method for automatically populating the pre-screen list of FIG. 7 for a closed-end fund (CEF) in accordance with aspects of the invention.

FIG. 8E is a flowchart illustrating a method for automatically populating the pre-screen list of FIG. 7 for Equities (Individual Stocks) in accordance with aspects of the invention.

FIG. 9 illustrates a copy of a portion of the submittal page for an equity sector portfolio analysis on a user interface.

FIG. 10 illustrates an example portion of a view in a custom portfolio review on a user interface.

FIG. 11 illustrates the tool that a user such as an analyst utilizes.

FIGS. 12-15 illustrate a user interface having a button/tab or icon on which a user clicks in order to commence the auto-sell function.

### DESCRIPTION OF THE PREFERRED EMBODIMENTS

The following description of the embodiments of the present invention is merely exemplary in nature and is in no way intended to limit the invention, its application, or uses. The present invention has broad potential application and utility. The following description is provided herein solely by way of example for purposes of providing an enabling disclosure of the invention, but does not limit the scope or substance of the invention.

The computer system of the present invention is a dedicated computer system for accomplishing investment portfolio analysis and rebalance.

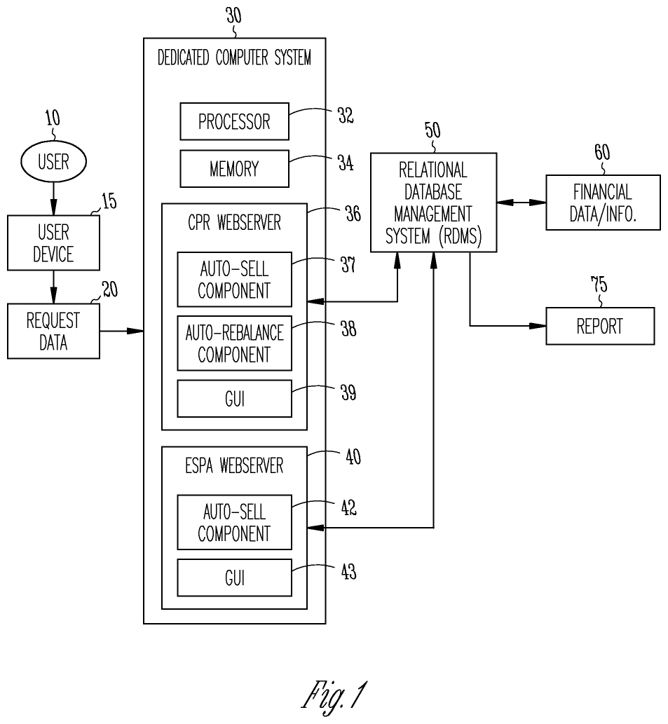

FIG. 1 illustrates an environment in which the dedicated computer system of the present invention operates. The environment comprises a user 10 having a user device 15. The user 10 uses the user device 15 to send a request and any input data 20 to the dedicated computer system 30. The dedicated computer system 30 comprises a processor 32, memory 34, a CPR web server 36, and an ESPA web server 40.

The CPR web server 36 comprises a CPR auto-sell component 37, an auto-rebalance component 38, and a CPR graphical user interface (GUI) 39.

The ESPA web server 40 comprises an ESPA auto-sell component 42 and an ESPA graphical user interface (GUI) 43.

Each of the CPR web server and the ESPA web server is communicatively connected to a relational database management system/server (RDMS) 50. The RDMS 50 is communicatively connected to other sources of financial data and information 60. The RDMS can automatically generate a report(s) 75.

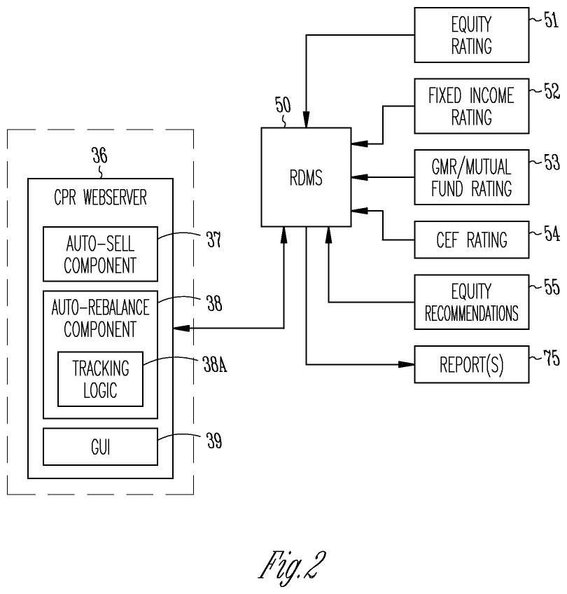

FIG. 2 is a diagram illustrating the computer system from the perspective of the CPR web server 36. In the RDMS 50, various recommendation lists, ratings and portfolio details are stored. Portfolio details have current and recommended allocations and percents. An example of information and data sent to the RDMS 50 includes, but is not limited to, equity rating 51, fixed income rating 52, proprietary manager research analyses (GMR) 53, closed-end fund (CEF) rating 54, and equity recommendation 55. The RDMS 50 can automatically generate a report(s) 75. The RDMS 50 can store data for account holdings, financial advisors, ratings, assets and sector classifications, prices, among others.

The CPR web server 36 creates a portfolio from holding information that is edited and reviewed by a financial advisor(s) and other analysts. Analysts may access and analyze the portfolio and recommended equities, funds, ETPs, bonds, internal and external advisory account sells and buys. In addition to the features of auto-sell and auto-rebalance, the CPR web server may comprise other components such as auto-purchase alternatives, rating maintenance pages, sector views, capital-markets assumptions views, and consolidated portfolio view. The CPR web server also comprises efficient frontier graph with portfolio tracking error of current portfolio and recommended portfolio. The CPR web server may also comprise a quality control process.

As indicated above, the RDMS 50 can generate a report(s) 75 in various formats such as excel or pdf. The reports are typically sent to a financial advisor and contain a portfolio proposal with current and recommended summary, asset allocation details, efficient frontier graph, risk metrics and tracking error.

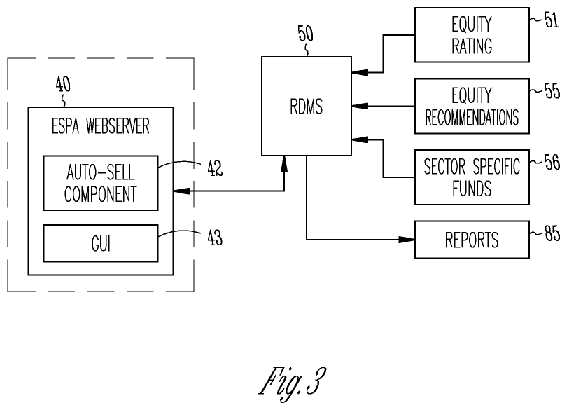

FIG. 3 is a diagram illustrating the computer system from the perspective of the ESPA web server 40. In the RDMS 50, various recommendation lists, ratings and portfolio details are stored. Portfolio details have current and recommended allocations and percents. An example of information and data sent to the RDMS 50 includes, but is not limited to, equity rating 51, equity recommendation 55, and sector specific funds 56. The RDMS 50 can also store for account holdings, financial advisors, ratings, assets and sector classifications, prices, among others. The ESPA web server 40 creates a portfolio from holding information that is edited and reviewed by a financial advisor(s) and other analysts. Analysts may access and analyze the portfolio and recommend equity sells and buys. In addition to the features of the sector allocation analysis, the ESPA web server 40 may comprise other components such as auto-sell 42. The ESPA web server may also comprise a quality control process.

The RDMS 50 can automatically generate a report(s) 85 in various formats such as excel or pdf. The reports 85 can be sent to a financial advisor and contain a portfolio proposal with current and recommended sector weightings.

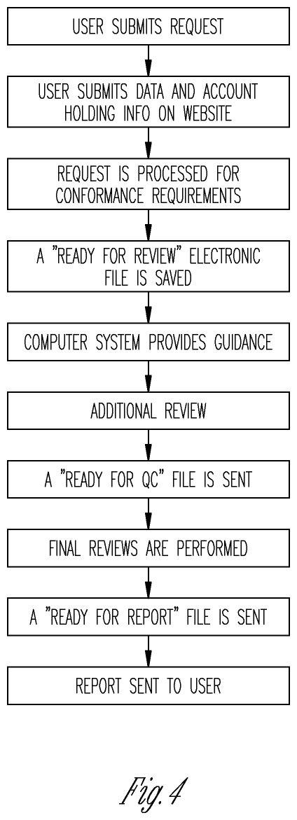

FIG. 4 is a process flow diagram in accordance with aspects of the present invention. As illustrated in FIG. 4, a user who desires to have a portfolio analysis by equity sector (ESPA) submits a request via a user device to the computer system. A “user” may be any individual or entity such as a financial advisor or portfolio analyst. There is a website on the intranet or internet through which a user can submit data and account-holdings information (or information on a portfolio of a prospect). Prior to analyst review, the submittal is processed to ensure that accounts, and securities within the accounts, conform to certain requirements and that any information or instructions are perspicuous. Once it is determined that a submittal is in accordance with the guidelines, the portfolio is sent to in an electronic file or to an electronic folder for “Ready for Review” and the “Ready for Review” electronic file is saved. The portfolios are then reviewed to render initial suggestions as to which securities should be sold, held, or purchased with the use of a computer-implemented template. The computer system provides guidance as to various stocks including those of third party research providers. There are also various auto-functions that are available to the reviewers. There is also a step for additional review.

Once reviewed, the file is then saved to another electronic file or electronic folder such as “Ready for Quality Control (QC).” Final reviews are performed. During the QC process, various research tools are utilized such as Bloomberg, Factset, Morningstar Direct, among others. The computer system application tools are used to weigh the tradeoffs between what may be an ideal allocation versus not causing excessive turnover.

Once the QC process has been performed the file is saved to another electronic file or electronic folder in preparation for reporting such as a “Ready for Report” electronic file or folder. At this time another quality check may be conducted, for example, determining if the sectors each equal their recommended weightings. A preliminary report and/or a final report can be sent to the user. The output of the computer system can generate specific discernible reallocations based on the recommendations, and in other instances may be used to persuade an investor or potential investor to pursue some form of professional management program.

Referring now to the ESPA web server 40, the computer software application tools/components of this web server are used to provide portfolio review of individual equities and sector-specific investment companies. The sector-allocation advice used for each portfolio is provided in accordance with the sector-allocation recommendations provided by investment strategists. The securities that are chosen to populate the sector allocations depend upon the investment objective and risk tolerance of a client. Additionally, the holdings within each sector are evaluated in an attempt to reduce/prevent over-allocation to various sub-industries. For example, generally do not want the entire allocation to the financials sector to be exclusively in banks, also do not want the entire allocation to consumer discretionary to be exposed only to restaurants. Also, concentrated (large as a percentage of the portfolio) positions are reduced to a maximum designated percentage of the portfolio, for example, 5%. There is a minimum portfolio size for this type of service.

Referring now to the CPR web server 36, the computer software application tools/components of this web server are used to review all security types in a portfolio, not just individual equities and sector-specific investments. Portfolios are evaluated against current recommended allocations as well as recommended investments within sectors to ensure recommended portfolios are aligned with the investment objective and risk tolerance of an investor. Once the portfolio information of an investor is reviewed for proper format and fit with the program, an initial review and set of recommendations is created based on gaps between the portfolio of the client and the recommendations of the financial advisor. Specific buy, sell and hold recommendations are made for individual securities in the portfolio using automated tools as well as individual review and adjustments. The initial recommendations are then reviewed to ensure that the recommendations do not create excessive turnover in the portfolio. Once reviewed and any changes are made, the recommendations are processed to create a client report.

Thus, the CPR computer software application tool provides a portfolio review and recommendation approach for specific investor portfolios aligned with an investment objective and risk tolerance of an investor and based on recommendations for asset allocation and individual securities. A user such as a financial advisor submits information regarding the holdings in internal accounts, external accounts, or a combination thereof to the computer system.

While the custom portfolio review service is in many respects similar to an equity sector portfolio analysis, there are some differences. The CPR application tool offers recommendations on essentially all securities: individual bonds and stocks, mutual funds, closed-end funds (CEFs), exchange-traded tracking products (ETPs), and unit investment trusts (UITs). CPR, like ESPA, has a specified minimum portfolio size. This tool focuses more on capital markets assumptions (CMA)-based asset allocation, and sector allocation within the equity portion is secondary to CMA-based allocation.

The CPR component is a technology-driven computer software application tool. The computer methods of the present invention are computer-implemented and automated, beginning with the submittal process through final-report generation. Among the computer-implemented features are the following.

The auto-sell component functions to make the job easier for the portfolio reviewer, whether for custom portfolio review or an equity sector portfolio analysis. By clicking on an Auto-Sell tab, button, or icon, a program automatically completely liquidates securities, for example, on which an analyst does not have research coverage or if the only ratings that are provided are the equivalent of a sell rating. The auto-sell function also reduces positions above a certain allocation percentage to a reduced percentage. For example, the auto-sell function reduces positions that constitute an allocation greater than a designated maximum weight of a portfolio level. For example, reduces an allocation greater than 5% to a 5% level.

When a request for custom portfolio review includes a provision for alternatives, e.g., hedge-fund open-end funds and managed futures products, the products to be used to gain such exposure and their respective allocations are pre-determined by the investment objective/risk tolerance. As such, the program can auto-populate these allocations unless there are existing positions in these areas. When a user enters buy or hold suggestions, the template is automated to reflect portfolio totals and sub-totals.

In a program for custom portfolio review there are alternative views with which the assets can be reviewed. One is by capital-markets assumptions (CMA), another is by sector (for the equity exposure), and another one, referred to as “Consolidated View,” illustrates the existing and proposed holdings line by line. The holdings can be downloaded into a spreadsheet or other software program from the Consolidated View. Regarding the CMA view, it is important to note that the holdings in investment companies are delineated across various asset classes. In other words, a fixed-income fund that comprises 2% of the portfolio may appear as 0.5% short-term fixed income, 1% intermediate term, 0.4% long term and 0.10% cash.

By aligning a portfolio with stated investment objectives, there are increased probabilities that an investor or potential investor may achieve their goals. Moreover, by minimizing tracking error relative to the expected risk and return of the profile of the investor or potential investor, disappointments are less likely.

In another aspect of the invention, there is a computer software tool within the CPR web server to make it easier for a user to identify and recommend mutual fund exchange opportunities for A-shares. To illustrate with an example, in a review the analyst recommended liquidating the A-shares of the Company A, a fund, for allocation reasons. A-shares are a share class on which an upfront sales charge is typical assessed, sometimes referred to as a load. Based on the tool, the analyst has an opportunity to identify other funds into which the proceeds can be moved, for example, with no additional sales load charged to the client. Additionally, during the quality control stage, a user can view other suggested exchanges rendered by analysts during the review stage by clicking on the “View/Delete Free Fund Exchanges” link. The user can either approve or change these recommendations. Moreover, through this process, when an exchange is recommended, it is displayed prominently in a separate area of the report to reduce the chance that it will be missed.

There are certain situations in which a security in a portfolio needs to be liquidated because of rules and recommendations that are in place. Examples include, but are not limited to, securities on which there is no coverage (including from external research providers), securities whose price per share is less than a specified dollar amount (for example, $5), closed-end funds on a “Closed-End Funds to Avoid List”, and equity positions included in S&P (GICS) Sectors on which a specified percentage allocation (for example, 0%) is recommended. To ameliorate this process and to prevent a situation in which a user may miss a security that should be liquidated, there is logic in place to automatically liquidate these securities in the review. In addition, this tool significantly reduces the time required to perform the CPR or ESPA analysis. A user has the ability to override the auto-sell suggestion.

The CPR web server also comprises a computer software application for auto-rebalance. The computer software application tool/component for auto-rebalance also includes tracking logic 38 A as shown in FIG. 2.

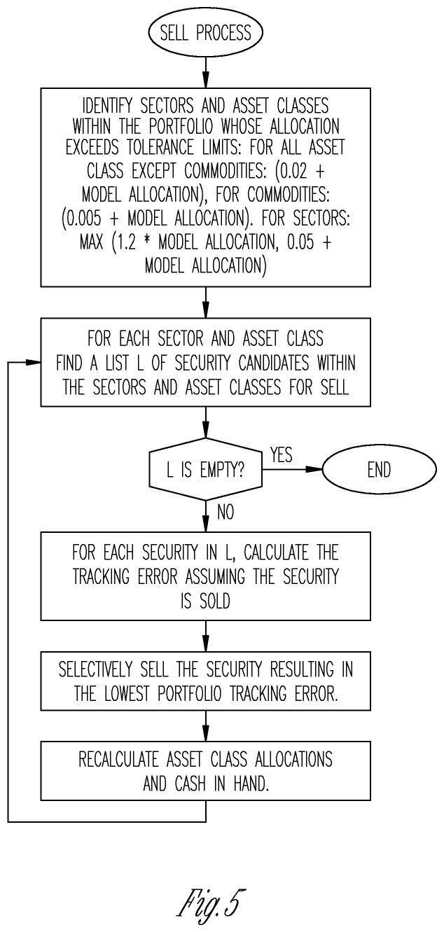

FIG. 5 is a process flow diagram of the auto-rebalance logic for a sell process in custom portfolio review. As shown in FIG. 5, for the sell process, the sectors and asset classes within the portfolio whose allocation exceeds a tolerance limit(s) (such as ±X %) are identified, where X % is a designated percentage for the tolerance limit. An example for all asset classes, except for commodities, is model allocation ±2% of the portfolio value. For commodities, an example of a tolerance band is model allocation ±0.5%. An example for sectors is max(1.2*model allocation, 5%+model allocation).

As shown in process flow, for each sector and asset class, a list L of security candidates within the sectors and asset classes to “sell” is identified. The question is asked if list L is empty. If so, the process ends. If list L is not empty, for each security in list L, the tracking error of the portfolio excluding that particular security is calculated. The security whose exclusion leaves the portfolio with the lowest tracking error relative to its benchmark is liquidated or sold. Asset-class allocations and cash in hand are recalculated and then returned to identify, for each sector and asset class, a list L of security candidates within the sectors and asset classes to sell.

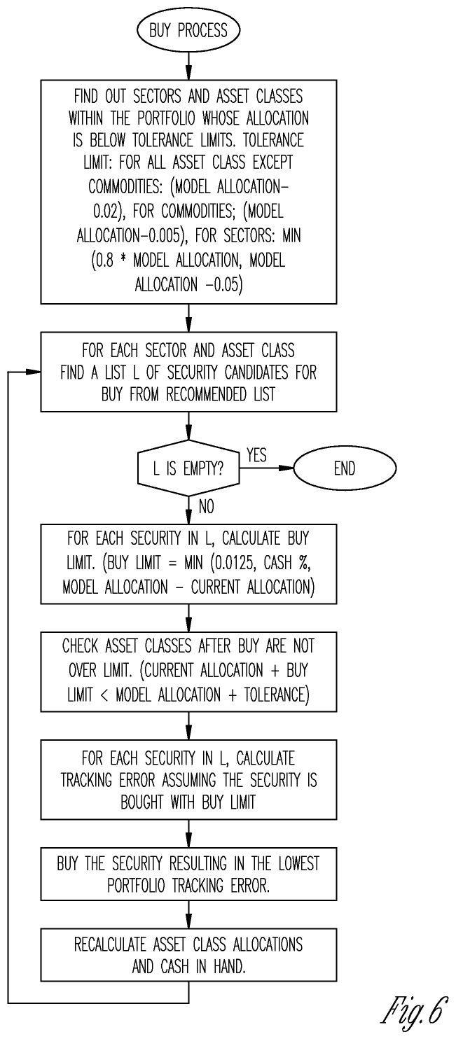

FIG. 6 is a process flow diagram of the auto-rebalance logic for a buy process in custom portfolio review.

As shown in FIG. 6, for the buy process, the sectors and asset classes within the portfolio whose allocation is below tolerance limits are identified. An example for all asset classes, except for commodities, is model allocation ±2% of the portfolio value. An example of the tolerance band for commodities is model allocation ±0.5%. An example for sectors is min(0.8*model allocation, model allocation−5%). As with the other examples, these are example percentages but the invention is not limited to these percentages.

As shown in process flow, for each sector and asset class, a list L of security candidates within the sectors and asset classes to “buy” from recommended list is identified. The question is asked if list L is empty. If so, the process ends. If list L is not empty, for each security in list L, the buy limit is calculated. An example of a buy limit is min(1.25%, cash %, model allocation-current allocation). Asset classes and post security purchases are reviewed to ensure that they are not over the prescribed buy limit. An example is (current allocation+buy limit<model allocation+tolerance). For each security in L, tracking error is calculated assuming the security is bought at the determined limit. The security is bought whose inclusion results in the lowest tracking error for the portfolio relative to its benchmark. Asset-class allocations and cash on hand are recalculated. The process returns to the step of identifying for each sector and asset class a list of L security candidates for buy from recommended list.

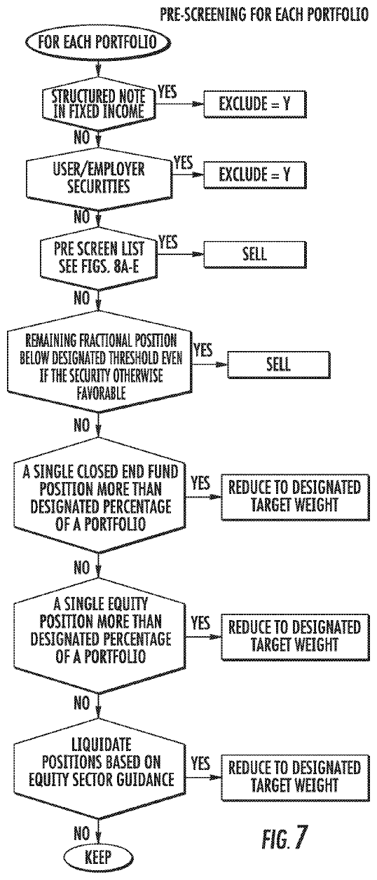

FIG. 7 is a flowchart illustrating the methodology for automated general pre-screening for a portfolio. As shown in FIG. 7, the question is posed as to whether the fixed-income obligation is a structured note. A structured note is a fixed-income obligation that usually offers returns related to the performance of an index, other security or the like. If yes, it is excluded. If no, the next question posed is whether it is a security on which an analyst cannot opine because of regulatory considerations; for example, it may be a stock, bond, warrant or other obligation of the financial institution with which the analyst is employed. If yes, it is excluded. If no, then move to the pre-screen list.

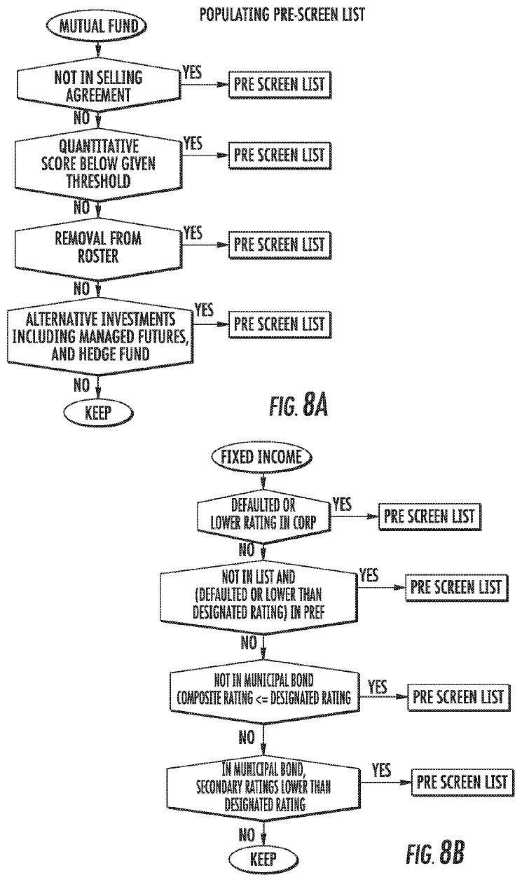

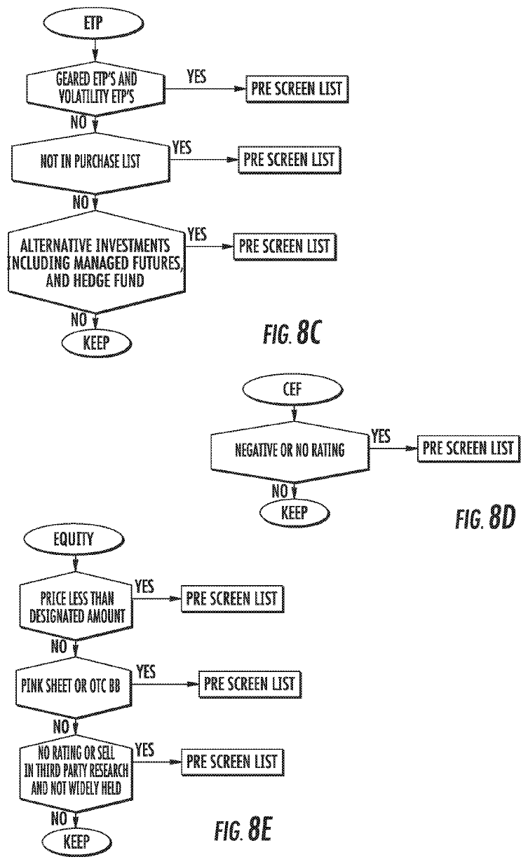

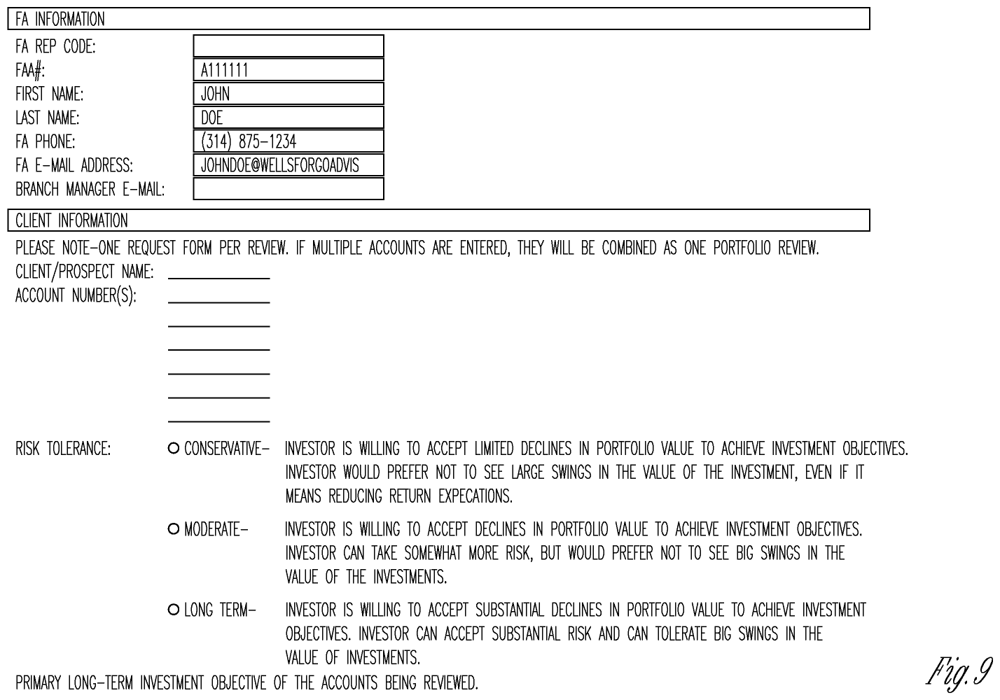

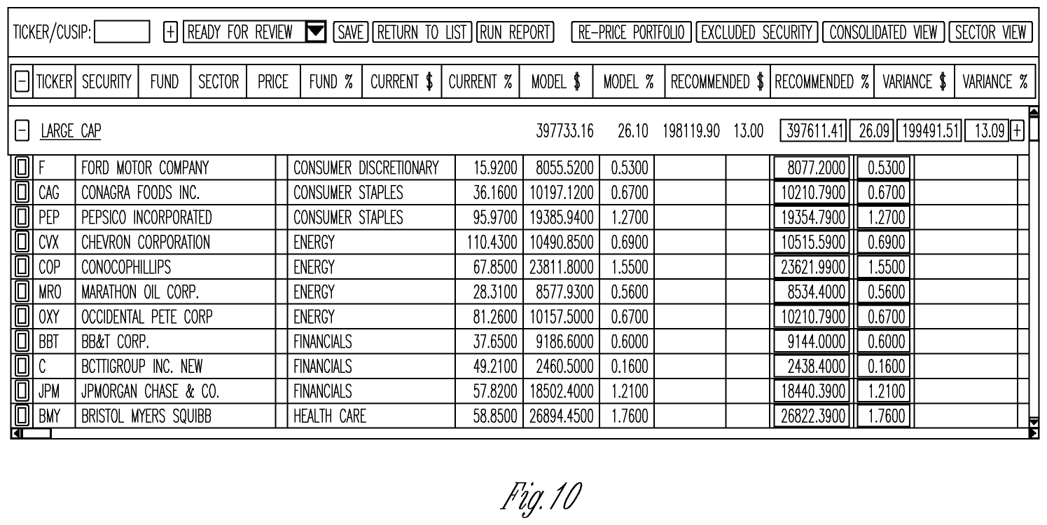

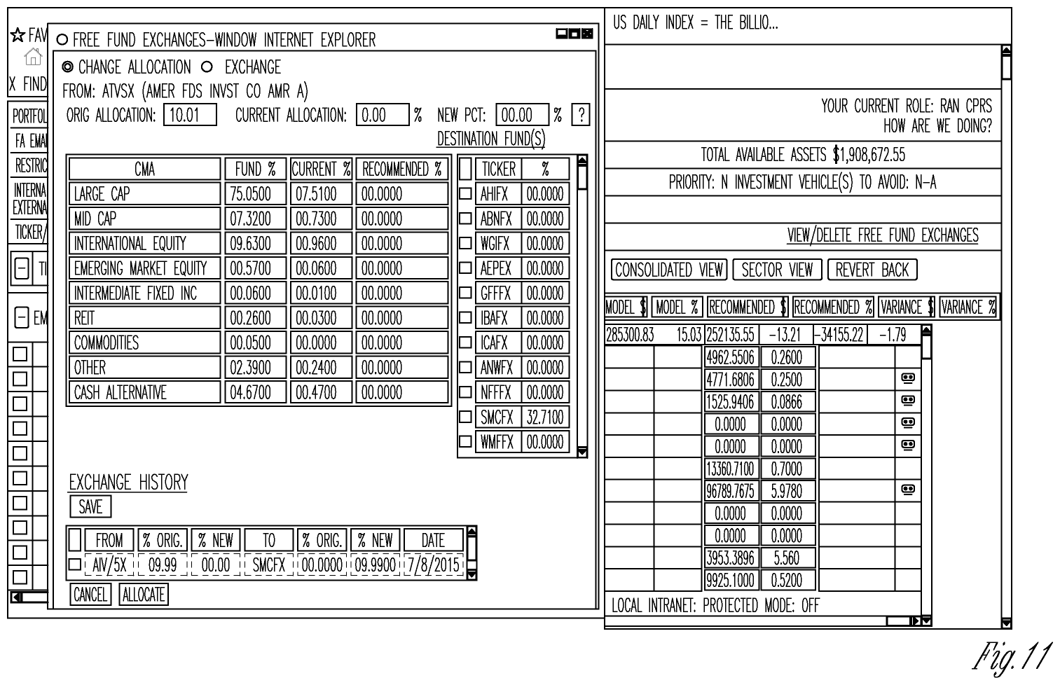

The pre-screen list is populated based upon the logic flow of one of FIGS. 8A-8E, discussed hereinafter, depending upon whether have a mutual fund (FIG. 8A), fixed income (FIG. 8B), ETP (FIG. 8C), CEF (FIG. 8D), or equity (FIG. 8E), for example.

After the pre-screen list, the question is posed whether the position is a fractional position (e.g., below a certain percentage threshold of the portfolio) even if the security is otherwise favorable. If yes, it is sold.

If not, a question is posed if a single closed-end fund position is more than a designated percentage of the portfolio. If yes, it is reduced to a designated target weight. For example, closed-end funds, even if they are constituents of a Hold or Select (Buy) List, are sold if their current allocation is greater than a stated percentage amount of the portfolio (e.g., 20% or more or the portfolio value).

A question is posed if a single equity position is more than a designated percentage of the portfolio. If yes, it is reduced to a designated target weight. For example, individual stocks, even if they are recommended for purchase or to be held, they are sold if their current allocation is greater than a stated percentage amount of the portfolio (e.g., 5% or more or the portfolio value).

The next question asks whether there is a need to liquidate positions based on equity sector guidance. For example, for any stock (or sector-specific investment product) that is included in a sector on which a specified percentage allocation (such as 0%) is recommended, then it is sold.

FIG. 8A is a flowchart illustrating a method for automatically populating a pre-screen list for a Mutual Fund in accordance with aspects of the invention. As shown in FIG. 8A, the tool identifies if there is a selling agreement in place with the particular fund family. If there is not a selling agreement it goes to the pre-screen list (flagged for likely liquidation). If there is a selling agreement, then it goes to the next step. If the quantitative-evaluation score is below a given threshold, then it goes to the pre-screen list. For example, if the particular fund fails quantitative tests and falls in the lower ten percent of funds, then it goes to the pre-screen list. Otherwise, it goes to the next step. If the fund has been removed from a roster such as a Mutual Fund Roster within a given time period such as the past 90 days, then it goes to the pre-screen list. Otherwise, it goes to the next step. The next question posed is whether the fund is an alternative investment such as managed futures or hedge funds. The latter would include funds that have investment strategies similar to those of some hedge fund managers, e.g. long/short funds, merger arbitrage funds, “all market” funds, etc. If yes, it goes to the pre-screen list, otherwise it may be kept in the portfolio.

FIG. 8B is a flowchart illustrating a method for automatically populating the pre-screen list for fixed income in accordance with aspects of the invention. As shown in FIG. 8B, the program determines if the fixed-income obligation is in default. If yes, then it goes to pre-screen. Otherwise, it goes on to the next step. The next question posed is whether it is a preferred security and not on a preferred excluded list. If yes, it goes to the pre-screen list, otherwise on to the next step. If the bond is not a municipal bond (e.g. most taxable fixed income including corporate, sovereign, etc.) the question is posed whether the composite rating is less than or equal to a designated rating such as ≤CCC+. If so, it goes to the pre-screen list. Otherwise, it goes on to next step. Next, the question posed is if the obligation is a municipal bond (tax-free or taxable) or whether the secondary rating is lower than a designated rating such as S&P≤BB+ or Moody's≤Ba1. If yes, then it moves to the pre-screen list, otherwise it may be kept in the portfolio.

FIG. 8C is a flowchart illustrating a method for automatically populating the pre-screen list for an Exchange-Traded Tracking Product (ETP) in accordance with aspects of the invention. ETPs include Exchange-Traded Funds (ETFs) and Exchange-Traded Notes (ETNs) and similar instruments. As shown in FIG. 8C, the first question posed is whether it is a geared ETP (GETP) which is typically a fund designed to provide 2×, 3×, −1×, −2× or −3× the performance of the underlying index with daily, monthly, etc. resets. If yes, it is moved to the pre-screen list. The question is also posed whether it is an ETP that is designed to track a volatility index. Volatility ETPs are moved to the pre-screen list. The question is posed whether the product is not listed on an allowed list (not all ETPs are available for purchase, particularly if an ETP has recently been launched, has not garnered significant assets, among other reasons). If yes (not on an allowed list), it gets moved to the pre-screen list. If it is a product with an alternative investments strategy or is a managed futures product, it is moved to the pre-screen list.

FIG. 8D is a flowchart illustrating a method for automatically populating the pre-screen list for a closed-end fund (CEF) in accordance with aspects of the invention. As shown in FIG. 8D, the question posed is whether the fund is on an avoid (negative) list or not rated. If so, it is moved to the pre-screen list.

FIG. 8E is a flowchart illustrating a method for Equities (Individual Stocks) in accordance with aspects of the invention. As shown in FIG. 8E, the question posed is whether the market price of the stock is less than a designated amount such as “X” dollars per share. For example, where X is $5. If yes, it goes to the pre-screen list, otherwise it goes onto the next step. The next question posed is whether it is a “pink sheet” stock or a “bulletin board” stock. Pink sheet stocks and bulletin board stocks are stocks that are usually thinly traded and can be quite volatile. If the answer is yes, it goes to the pre-screen list, otherwise onto the next step. The next question posed is whether it is not rated by a designated advisory services group or any designated research providers or the only rating provided by such providers is a sell. If either of these scenarios is true, it goes to the pre-screen list.

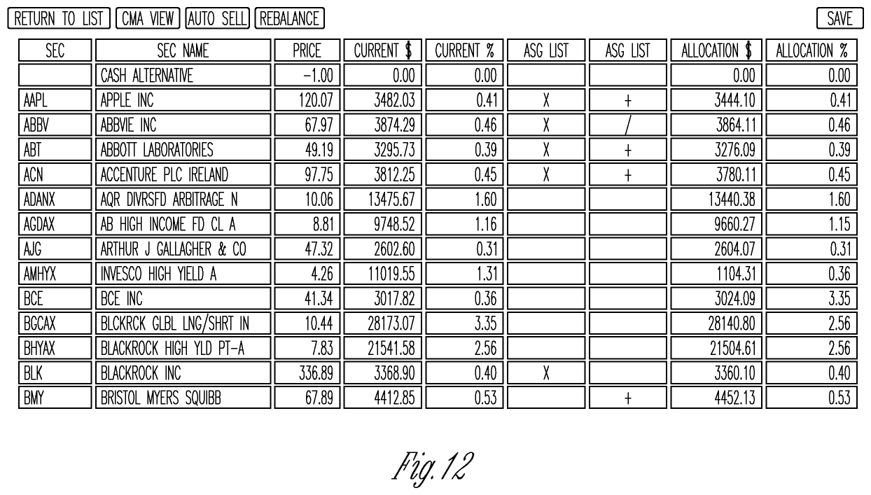

FIG. 9 illustrates a copy of a portion of the submittal page for Equity Sector Portfolio Analysis.

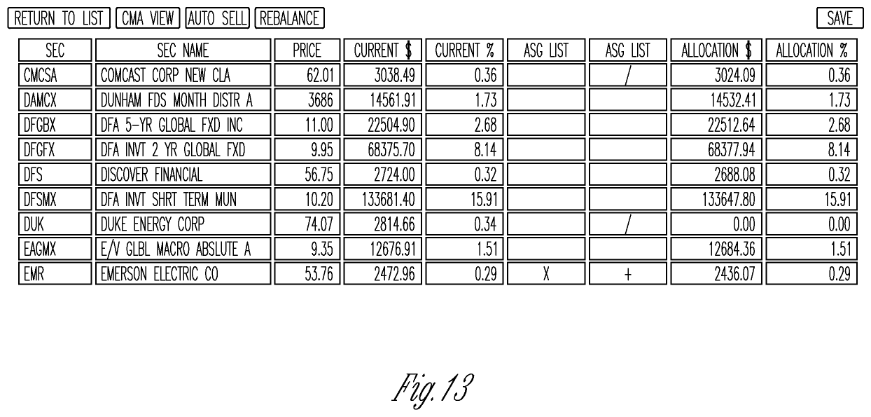

FIG. 10 illustrates an example portion of a capital-markets assumptions (CMA) view.

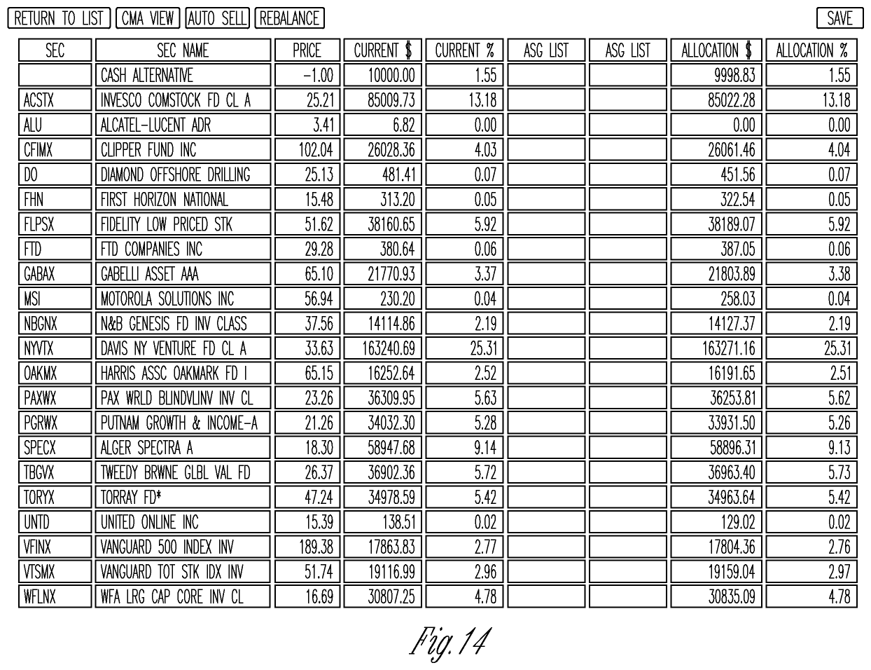

FIG. 11 illustrates a computer screenshot of the tool that a user such as an analyst utilizes.

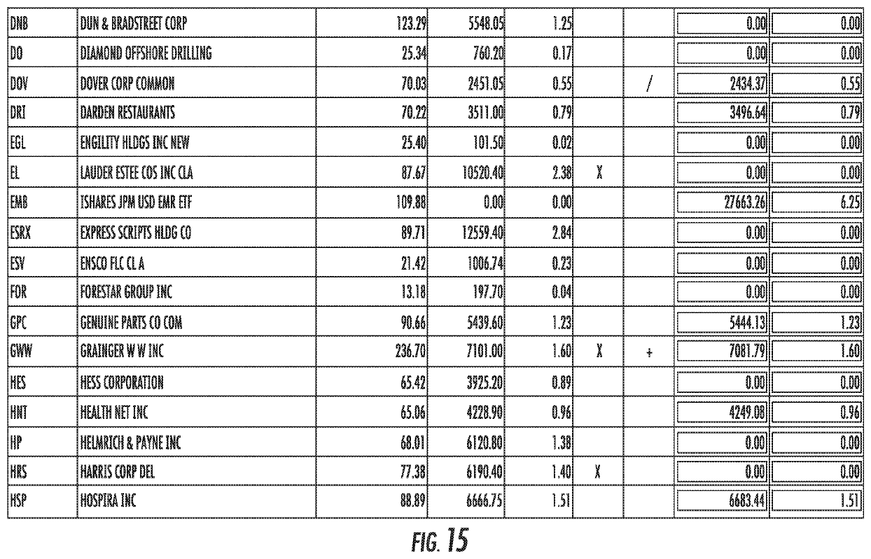

FIGS. 12-15 illustrate a user interface having a button on which a user clicks in order to commence the auto-sell function. As shown in FIGS. 12-15 within the consolidated view, a user is able to view the remaining securities within a portfolio along with their corresponding weights relative to the total portfolio value. By clicking on a “Rebalance” button, the auto-rebalance is executed which runs the logic that has been designed in order to rebalance the portfolio. The auto-rebalance utilizes a step-wise optimization algorithm to provide buy, hold and sell recommendations that minimize the deviation of the actual portfolio from target guidelines, as well as, portfolio turnover. At each step, a list of individual trade ideas is generated that reduces the asset class weight deviation from the target of the actual portfolio. For example, if the target weight of domestic large cap equity is 28%, then the rebalancing logic is constrained to keep the proposed weight in domestic large cap equity between 26% and 30% given a 2% band. Then, the logic selects one recommended trade, based on the trade's effect on improving the portfolio's return deviation from the target, calculated by tracking error. The logic minimizes the portfolio turnover by focusing on over-allocated asset classes for sell recommendations and reinvestment recommendations are made only in-line with the cash generated by the originating sell recommendations. FIGS. 12-15 capture an example of the recommended trades from the logic following the auto-sell and then the auto-rebalance functions. The recommended trades have the weight adjustments noted in the columns to the right. Though the logic is not definitive of the final recommendations, the auto-rebalance function provides the analyst with an initial set of recommendations to rebalance the portfolio based on rules-driven logic.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

1. A method for custom review of an investment portfolio in a computer system comprising a processor configured to:
receive a plurality of data submissions from a plurality of web servers via a network interface, the plurality of data submissions including information regarding the investment portfolio;
process the plurality of data submissions to transform the plurality of data submissions to conform with format requirements;
save the processed plurality of data submissions to an electronic storage location of a relational database management system, the relational database management system communicatively connected to the plurality of web servers;
automatically generate a report indicating at least that the plurality of data submissions have been processed to transform the plurality of data submissions and saved to the electronic storage location accessible to the plurality of web servers:
send the report over the network interface to the plurality of web servers;
evaluate the investment portfolio against current recommended allocations and investments to align the investment portfolio with an investment objective and a risk tolerance of an investor, wherein the investment portfolio includes a list of securities;
automatically determine a lowest relative tracking error for the investment portfolio by calculating and comparing tracking errors for the investment portfolio by sequentially including each prospectively purchased security from the recommended allocations and investments, and by sequentially excluding each prospectively sold security from the list when calculating the tracking errors;
displaying an icon for rebalancing, a link for mutual fund exchanges, and an auto-sell icon within a consolidated view of a portion of the list of securities on a graphical user interface (GUI) in communication with the processor;
automatically rebalancing the investment portfolio upon sensing a user selection of the icon for rebalancing to provide a recommended portfolio;
automatically executing mutual fund exchanges upon sensing an approval indication by the user from the link for mutual fund exchanges;
automatically selling a security from the list upon sensing user selection of the auto-sell icon based on the lowest relative tracking error; and
displaying mutual fund exchange recommendations on a first portion of the GUI and a graph on a second portion of the GUI, the graph including tracking errors of the investment portfolio and the recommended portfolio.

2. The method according to claim 1, wherein the recommended portfolio includes purchase recommendations and selling recommendations, and wherein the purchase recommendations use prospective proceeds generated by the selling recommendations.

3. The method according to claim 2, wherein the processor is further configured to identify a sector or an asset class within the investment portfolio having an allocation below a tolerance limit.

4. The method according to claim 1, wherein automatically rebalancing the investment portfolio comprises automatically selling a security.

5. The method according to claim 4, wherein the processor is further configured to identify a sector or an asset class within the investment portfolio having an allocation that exceeds a tolerance limit.

6. A method for custom review of an investment portfolio in a computer system comprising a processor configured to:
receive a plurality of data submissions from a plurality of web servers via a network interface, the plurality of data submissions including information regarding the investment portfolio;
process the plurality of data submissions to transform the plurality of data submissions to conform with format requirements;
save the processed plurality of data submissions to an electronic storage location of a relational database management system, the relational database management system communicatively connected to the plurality of web servers;
automatically generate a report indicating at least that the plurality of data submissions have been processed to transform the plurality of data submissions and saved to the electronic storage location accessible to the plurality of web servers;
transmit the report over the network interface to the plurality of web servers;
identify a sector and an asset class within the investment portfolio whose allocation exceeds a tolerance limit;
generate a list of securities from the investment portfolio as candidates for sale within the sector and the asset class;
automatically calculate a lowest relative tracking error for the investment portfolio by:
in response to determining that the list is not empty, for a first security on the list, determine a first tracking error of the investment portfolio with the first security on the list excluded from the investment portfolio;
in response to determining that the list includes an nth security, determine an nth tracking error of the investment portfolio with the nth security on the list excluded from the investment portfolio;
compare each of the first through nth tracking errors to determine which is lowest relative to a benchmark for the investment portfolio to obtain the lowest relative tracking error;
displaying an auto-sell icon, a link for mutual fund exchanges, and a rebalance icon within a consolidated view of a portion of the list of securities on a graphical user interface (GUI) in communication with the processor;
automatically populating allocations for investment alternatives to be used in a recommended portfolio;
providing the recommended portfolio upon sensing user selection of the rebalance icon;
automatically executing mutual fund exchanges upon sensing an approval indication by the user from the link for mutual fund exchanges;
automatically selling a security from the list upon sensing a user selection of the auto-sell icon leaving the portfolio with the lowest relative tracking error; and
displaying mutual fund exchange recommendations on a first portion of the GUI and a graph on a second portion of the GUI, the graph including tracking errors of the investment portfolio and the recommended portfolio.

7. The method according to claim 6, wherein the list of securities is pre-screened.

8. The method according to claim 7, wherein the pre-screened list of securities comprises a security including one or more of mutual fund, fixed-income obligation, exchange-traded product, closed-end fund, or individual stock.

9. The method according to claim 8, wherein the pre-screened list excludes a fixed-income obligation that is a structured note.

10. The method according to claim 8, wherein the pre-screened list of securities comprises a closed-end fund.

11. The method according to claim 10, wherein automatically selling a security from the list includes automatically selling any closed-end fund having an allocation comprising less than X % of a total portfolio value of the investment portfolio, wherein X % is a designated percentage.

12. The method according to claim 10, wherein automatically selling a security from the list includes reducing an allocation to a specified percentage of a total portfolio value of the investment portfolio for any closed-end fund exceeding the specified percentage of the total portfolio value of the investment portfolio.

13. The method according to claim 8, wherein the pre-screened list of securities comprises an individual stock.

14. The method according to claim 13, wherein automatically selling a security from the list includes automatically selling any individual stock having an allocation comprising less than a specified percentage of a total portfolio value of the investment portfolio.

15. The method according to claim 13, wherein automatically selling a security from the list includes reducing an allocation to a designated maximum weight of the investment portfolio for any individual stock exceeding the designated maximum weight.

16. The method according to claim 13, wherein automatically selling a security from the list includes automatically selling the individual stock that is included in any sector having a specified percentage allocation.

17. A method for custom review of an investment portfolio a computer system comprising a processor configured to:
receive a plurality of data submissions from a plurality of web servers via a network interface, the plurality of data submissions including information regarding the investment portfolio;
process the plurality of data submissions to transform the plurality of data submissions to conform with format requirements;
save the processed plurality of data submissions to an electronic storage location of a relational database management system, the relational database management system communicatively connected to the plurality of web servers;
automatically generate a report indicating at least that the plurality of data submissions have been processed to transform the plurality of data submissions and saved to the electronic storage location accessible to the plurality of web servers;
transmit the report over the network interface to the plurality of web servers;
identify a sector and an asset class within the investment portfolio whose allocation is below a tolerance limit;
generate a list of securities as candidates for purchase within the sector and the asset class;
automatically calculate a lowest relative tracking error for the investment portfolio by:
in response to determining that the list is not empty, for a first security on the list, determine a first tracking error of the investment portfolio with the first security on the list added to the investment portfolio;
in response to determining that the list includes an nth security, determine an nth tracking error of the investment portfolio with the nth security on the list added to the investment portfolio;
compare each of the first through nth tracking errors to determine which is lowest relative to a benchmark for the investment portfolio to obtain the lowest relative tracking error;
displaying an icon for rebalancing, a link for mutual fund exchanges, and an auto-sell icon within a consolidated view of a portion of the list of securities on a graphical user interface (GUI) in communication with the processor;
automatically populating allocations for investment alternatives to be used in a recommended portfolio;
automatically buying a security from the list and providing the recommended portfolio upon sensing a user selection of the icon for rebalancing giving the portfolio the lowest relative tracking error;
automatically executing mutual fund exchanges upon sensing an approval indication by the user from the link for mutual fund exchanges;
automatically selling a security from the list upon sensing user selection of the auto-sell icon based on the lowest relative tracking error; and
displaying mutual fund exchange recommendations on a first portion of the GUI and a graph on a second portion of the GUI, the graph including tracking errors of the investment portfolio and the recommended portfolio.

18. The method according to claim 17, wherein the list of securities is pre-screened.

19. The method according to claim 18, wherein the list of securities comprises a security including one or more of mutual fund, fixed-income obligation, exchange-traded product, closed-end fund, or individual stock.

20. The method according to claim 18, wherein the processor is further configured to identify a sector or an asset class within the investment portfolio having an allocation below a tolerance limit.
